(19) United States
(12) Patent Application Publication
(10) Pub. No.: US 2009/0283583 A1
(43) Pub. Date: Nov. 19, 2009

(54) Two Tier Authentication

(75) Inventors: Russell Paul Cowburn, London (GB); Mark McGlade, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 12/465,534

(22) Filed: May 13, 2009

Related U.S. Application Data
(60) Provisional application No. 61/127,507, filed on May 14, 2008.

(30) Foreign Application Priority Data
May 14, 2008 (GB) 0808756.1

(51) Int. Cl. G06F 17/00; G06F 17/30; G06K 19/06

(52) U.S. Cl. 235/375; 707/104.1; 707/3; 235/494; 707/E17.044; 707/E17.108; 235/462.01

(57) ABSTRACT

There can be provided a complete and flexible multi-tier article authentication system. A number of implementation options are possible, and in one of which an article can include an applied code thereon, which applied code includes an identifier code for the article and a biometric type signature for the article, the biometric type signature having been generated from analysis of intrinsic surface or internal structure of a part of an article to which the applied code is applied.

### FIELD

The present invention relates to two tier authentication, and in particular, but not exclusively to use of two-tier authentication for determining the authenticity of an article.

### BACKGROUND

In the fields of authenticating of physical articles it is usual to rely upon an identifier for the article. The identifier may be a printed identifier such as a barcode, or it may be an electronic identifier such as an embedded electronic circuit such as an RFID (radio frequency identifier) chip. Alternatively, an identifier based on a physical property may be used, these can include embedded reflective particles or an unmodified surface of the article.

Each type of such authenticity identifier has its own advantages and disadvantages. For example, printed codes are easily and cheaply readable, and in the case of numeric or alphanumeric codes, can be read easily by an end consumer without any specialist equipment but are very easy to spoof or fake. RFID type systems provide a high level of accuracy and are hard to spoof or fake, but can be very costly to implement and require specialist reader equipment. Physical property based systems are also hard to spoof or fake and can be of lower cost per article to implement than RFID based systems and require specialist reader equipment.

The present invention has been conceived in the light of known drawbacks of existing systems.

### SUMMARY

Viewed from a first aspect, the present invention provides a complete and flexible multi-tier article authentication system. A number of different authentication systems are applied to a given article in order to allow multiple levels of authentication to be performed by different persons throughout the supply chain, and using different levels of equipment to perform the authentication. By using such a flexible approach, authenticity can be verified to one or more different levels, depending upon the interest, capability and equipment of an individual.

Viewed from a second aspect, the present invention can provide a method of preparing an article for later verification. The method can comprise generating a biometric type signature for an article from analysis of intrinsic surface or internal structure thereof; combining the biometric type signature for the article with an identifier code for the article; and applying the combined code to a part of the article from which the biometric type signature was generated. Thereby, an article can be created or prepared which can be authenticated or validated in a reliable manner without a need to refer to a database of valid article biometric type signatures. Additionally, any attempt to alter or tamper with the code on the article will result in a tampering with the article structure from which the biometric type signature is derived.

In some examples, the biometric type signature can be encoded before the combining. Thereby, reading the combined code and separating the biometric type signature part from the identifier code part would leave the biometric type signature unreadable by anyone not possessing the correct decoding protocol or key. In some examples, the encoding can use an asymmetric encryption algorithm such that the encoded barcode is protected using a one-way function. In some examples, the encryption could be symmetric. In such examples the key could be held securely in tamper-proof memory or crypto-processor smart cards on the authentication equipment. Thus secure protection of the biometric type signature can be provided.

In some examples, the combined code is a barcode. Thus the code as applied to the article can look to the uninitiated like the barcode that could appear on any number of products and thus give no clue as to the additional security inherent therein. In some specific examples the barcode can be a 2D barcode and thus provide for handling by the code of a large quantity of data in a relatively small surface area of the product. One example in which a 2D barcode might be used is where the article is a pharmaceutical product or pharmaceutical product packaging.

In some examples, the generating comprises: directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points. Thereby the biometric type signature can be generated in a manner strongly resistant to spoofing.

In some examples, the biometric type signature can be stored in a database. Thus provision can be made for making a validation check against a database as well as the provision already provided for a self-check. The biometric type signature record can be associated in the database with the identifier code for the article so as to provide for searching the database with a deterministic key.

In some examples, during a later verification a result can be determined from one or both of the identifier code and the biometric type signature, in accordance with a desired result authentication certainty level. Thus flexibility is provided as to the level of validation required.

In some examples, the identifier code for the article is assigned to the article according to the unique identity or group identify of the article to enable identification of the article distinct from other similar articles. Thus the article can be identified on the basis of the identifier code as well as on the basis of the biometric type signature.

Viewed from another aspect, the present invention can provide a method of validating the authenticity of an article. The method can comprise reading an assigned code from an article and extracting from the assigned code an identifier for the article and a biometric type signature for the article. The method can further comprise using the identifier as a first authentication method to determine the authenticity of the article by comparing the extracted identifier to a record of one or more valid identifiers; and using the biometric type signature as a second authentication method to determine the authenticity of the article by comparing the extracted biometric type signature to a biometric type signature generated from analysis of intrinsic surface or internal structure of an area of the article from where the applied code is read. Thereby, an article can be authenticated or validated in a reliable manner without a need to refer to a database of valid article biometric type signatures. Additionally, any attempt to alter or tamper with the code on the article will result in a tampering with the article structure from which the biometric type signature is derived.

In some examples, the biometric type signature can be encoded before the combining. Thereby, reading the combined code and separating the biometric type signature part from the identifier code part would leave the biometric type signature unreadable by anyone not possessing the correct decoding protocol or key. In some examples, the encoding can use an asymmetric encryption algorithm such that the encoded barcode is protected using a one-way function. In some examples, the encryption could be symmetric. In such examples the key could be held securely in tamper-proof memory or crypto-processor smart cards on the authentication equipment. Thus secure protection of the biometric type signature can be provided.

In some examples, the combined code is a barcode. Thus the code as applied to the article can look to the uninitiated like the barcode that could appear on any number of products and thus give no clue as to the additional security inherent therein. In some specific examples the barcode can be a 2D barcode and thus provide for handling by the code of a large quantity of data in a relatively small surface area of the product. One example in which a 2D barcode might be used is where the article is a pharmaceutical product or pharmaceutical product packaging.

In some examples, the generating comprises: directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points. Thereby the biometric type signature can be generated in a manner strongly resistant to spoofing.

In some examples, the biometric type signature can be used as a third authentication method by comparing the biometric type signature generated from analysis of intrinsic surface or internal structure of an area of the article from where the applied code is read to a biometric type signature retrieved from a database. Thus provision can be made for making a validation check against a database as well as the provision already provided for a self-check. The biometric type signature record can be associated in the database with the identifier code for the article so as to provide for searching the database using the identifier code as a deterministic key.

In some examples, the third authentication method can be selectively used for less than all articles subjected to the method, wherein articles are selected for use of the third authentication method in accordance with one or more of: a random selection, a maximum number of articles interval, a perceived damage to the applied code, and an encoding protocol or signature used to encode the biometric type signature in the applied code. Thus the third authentication method can be employed in the manner of a supplementary backup checking method and/or as a escalation checking method.

In some examples, an authentication result can be determined from one or both of the first and second authentication methods, in accordance with a desired result authentication certainty level. Thus flexibility is provided as to the level of validation required.

In some examples the desired result authentication certainty level is predetermined in accordance with one or more of an intended use of the article, the nature of the article, a service entitlement provided by the article, an access entitlement provided by the article, the value of the article or a rights level of an operator. Thus a default condition can be set according to one of a number of parameters.

In some examples, the desired result authentication certainty level is adjusted following receipt of an authenticity result from the first authentication method. Thus an escalation of the required level of authentication can be made if a result from the first method indicates this to be required.

In some examples, the identifier code for the article is assigned to the article according to the unique identity or group identify of the article to enable identification of the article distinct from other similar articles. Thus the article can be identified on the basis of the identifier code as well as on the basis of the biometric type signature.

Viewed from another aspect, the invention can provide apparatus for preparing an article for later verification. The apparatus can comprising a scanning unit operable to scan an article to perform analysis of intrinsic surface or internal structure thereof, a processing unit operable to generate a biometric type signature for an article from data gathered by the scanning unit. a processing unit operable to combine the biometric type signature for the article with an identifier code for the article, and a printing unit operable to apply the combined code to a part of the article scanned by the scanning unit. The processing unit operable to generate a biometric type signature can be the same as or different to the processing unit operable to combine the biometric type signature with the identifier code. Thereby, an article can be created or prepared which can be authenticated or validated in a reliable manner without a need to refer to a database of valid article biometric type signatures. Additionally, any attempt to alter or tamper with the code on the article will result in a tampering with the article structure from which the biometric type signature is derived.

Viewed from a further aspect, the present invention can provide apparatus for validating the authenticity of an article. The apparatus can comprise a reading unit operable to reading an assigned code from an article, a processing unit operable to extract from the assigned code an identifier for the article and a biometric type signature for the article, a comparison unit operable to use the identifier as a first authentication method to determine the authenticity of the article by comparing the extracted identifier to a record of one or more valid identifiers, and a comparison unit operable to use the biometric type signature as a second authentication method to determine the authenticity of the article by comparing the extracted biometric type signature to a biometric type signature generated from analysis of intrinsic surface or internal structure of an area of the article from where the applied code is read. The two comparison units can be the same unit or different units. Thereby, an article can be authenticated or validated in a reliable manner without a need to refer to a database of valid article biometric type signatures. Additionally, any attempt to alter or tamper with the code on the article will result in a tampering with the article structure from which the biometric type signature is derived.

Viewed from another aspect, the present invention can provide an article comprising an applied code thereon, which applied code includes an identifier code for the article and a biometric type signature for the article, the biometric type signature having been generated from analysis of intrinsic surface or internal structure of a part of an article to which the applied code is applied. Thereby, an article can be provided which can be authenticated or validated in a reliable manner without a need to refer to a database of valid article biometric type signatures. Additionally, any attempt to alter or tamper with the code on the article will result in a tampering with the article structure from which the biometric type signature is derived.

Viewed from another aspect, there can be provided a system for validating the authenticity of an article. The system can comprise using an assigned code applied to the article as a first authentication method to determine the authenticity of the article and using a biometric type signature for the article generated from intrinsic structure thereof as a second authentication method to determine the authenticity of the article. An authenticity result can be determined from one or both of the first and second authentication methods, in accordance with a desired result certainty level. A corresponding method and apparatus can be provided.

In some examples, the assigned code is readable from the article without the use of a reading apparatus so as to enable unassisted human reading of the code. In some examples the assigned code is one of a numerical code, an alphanumerical code, and a barcode, thus providing flexibility as to coding choice.

In some examples, using an assigned code as an authentication method comprises comparing the assigned code to a stored code, and returning an authenticity result in dependence upon the result of the comparing. Thus a simple comparison to a stored record can be used to determine the authenticity. In some examples, the stored code is stored at a location remote from an authentication equipment for authenticating the article, thus enabling a remote database to be employed.

In some examples, the biometric type signature is generated by directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points. Thus the biometric type signature can be very reliable and secure being based upon intrinsic structure of the article and obtained in a repeatable way.

In some examples, using the biometric type signature as an authentication method comprises comparing the signature to a stored signature, and returning a authenticity result value in dependence upon the result of the comparing. Thus a comparison to a database of signature can be used to determine the validity or authenticity. In some examples, the database is stored at a location remote from an authentication equipment for authenticating the article, thus enabling a remote database to be used.

In some examples, the assigned code is used to identify a candidate stored signature from the database for comparison to the biometric-type signature. This enables the biometric comparison to be carried out faster as it avoids a need for a 1:many match of fuzzy signatures.

In some examples, the stored signature can be stored in or on the article, thus allowing a check to be made without recourse to a remote database or a need to carry a copy of the database. The stored signature can be encoded into a barcode, microcontroller or RFID tag.

In some example, the desired certainty level is predetermined in accordance with one or more of an intended use of the article, the nature of the article, a service entitlement provided by the article, an access entitlement provided by the article, the value of the article or a rights level of an operator. Thus the system is flexible to meet the particular needs of an implementation.

In some examples, the desired result certainty level is adjusted following receipt of an authenticity result from the first authentication method. Thus the code based authentication can be used to select between one of a number of required overall certainty levels.

Viewed from another aspect, there can be provided a back-end system to support such validation. The system can comprise one or more database stores and one or more database comparison units, wherein the database stores hold record codes and record signatures for articles and wherein the database search units enable a search to be preformed in the database for each of a received code and a received signature, and an authenticity for each of a received code and a received signature to be created. A corresponding method and apparatus can be provided.

Viewed from a further aspect, there can be provided system for tracking an article, the system comprising: using a biometric type signature for the article generated from intrinsic structure thereof to retrieve a record relating to the article; and using the record to determine at least a part of a life history for the article. Thus a tracking arrangement can be adopted to perform code-based tracking from the biometric signature, even if a code has been removed from the article. A corresponding method and apparatus can be provided.

In some examples, the record is an applied code for the article. In some examples, the applied code has been previously removed from the article. In some examples, the life history for the article includes details of manufacture, packaging and/or transport.

A back-end system to support such tracking can also be provided, including a life history record associated with a code and/or a biometric signature such that the life history can be retrieved in response to a search using the biometric signature. A corresponding method and apparatus can be provided.

In some examples, the system for verification and the tracking systems can be operated in a combined manner. A corresponding method and apparatus can be provided.

Further objects and advantages of the invention will become apparent from the following description and the appended claims.

### BRIEF DESCRIPTION OF THE DRAWINGS

For a better understanding of the invention and to show how the same may be carried into effect reference is now made by way of example to the accompanying drawings in which:

FIG. 1 shows a schematic side view of a reader apparatus;

FIG. 2 shows a block schematic diagram of functional components of the reader apparatus;

FIG. 3 is a microscope image of a paper surface;

FIG. 4 shows an equivalent image for a plastic surface;

FIG. 5 shows a flow diagram showing how a signature of an article can be generated from a scan;

FIG. 6 is a flow diagram showing how a signature of an article obtained from a scan can be verified against a signature database;

FIG. 7a is a plot illustrating how a number of degrees of freedom can be calculated;

FIG. 7b is a plot illustrating how a number of degrees of freedom can be calculated;

FIG. 8 is a flow diagram showing the overall process of how a document is scanned for verification purposes and the results presented to a user;

FIG. 9a is a flow diagram showing how the verification process of FIG. 6 can be altered to account for non-idealities in a scan;

FIG. 9b is a flow diagram showing another example of how the verification process of FIG. 6 can be altered to account for non-idealities in a scan;

FIG. 10A shows an example of cross-correlation data gathered from a scan;

FIG. 10b shows an example of cross-correlation data gathered from a scan where the scanned article is distorted;

FIG. 10C shows an example of cross-correlation data gathered from a scan where the scanned article is scanned at non-linear speed;

FIG. 11 is a schematic representation of an article for verification;

FIG. 12 is a flow chart setting out representative steps of a verification process from the point of view of a user;

FIG. 13 is a flow chart setting out representative steps of a verification process from the point of view of a verification apparatus;

FIGS. 14a and 14b are flow charts setting out representative steps of a verification process from the point of view of a database server; and

FIG. 15 is a flow chart setting out representative steps of a process of preparing an article for later verification;

FIG. 16 is a flow chart setting out representative steps of a verification process from the point of view of a verification apparatus; and

FIGS. 17a and 17b are schematic representations of an article for verification.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### SPECIFIC DESCRIPTION

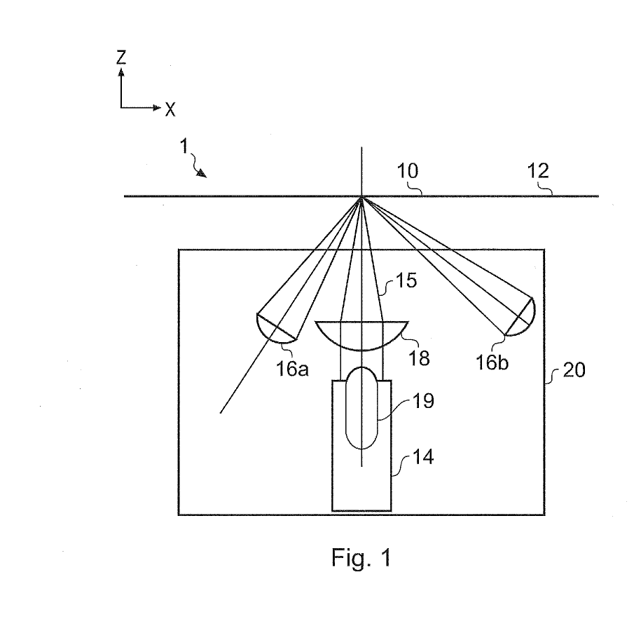

To provide an accurate method for uniquely identifying an article, it is possible to use a system which relies upon optical reflections from a surface of the article. An example of such a system will be described with reference to FIGS. 1 to

The example system described herein is one developed and marketed by Ingenia Technologies Ltd. This system is operable to analyse the random surface patterning of a paper, cardboard, plastic or metal article, such as a sheet of paper, an identity card or passport, a security seal, a payment card etc to uniquely identify a given article. This system is described in detail in a number of published patent applications, including GB0405641.2 filed 12 Mar. 2004 (published as GB2411954 14 Sep. 2005), GB0418138.4 filed 13 Aug. 2004 (published as GB2417707 08 Mar. 2006), U.S. 60/601,464 filed 13 Aug. 2004, U.S. 60/60 1,463 filed 13 Aug. 2004, U.S. 60/610,075 filed 15 Sep. 2004, GB 0418178.0 filed 13 Aug. 2004 (published as GB2417074 15 Feb. 2006), U.S. 60/601,219 filed 13 Aug. 2004, GB 0418173.1 filed 13 Aug. 2004 (published as GB2417592 01 Mar. 2006), U.S. 60/601,500 filed 13 Aug. 2004, GB 0509635.9 filed 11 May 2005 (published as GB2426100 15 Nov. 2006), U.S. 60/679,892 filed 11 May 2005, GB 0515464.6 filed 27 Jul. 2005 (published as GB2428846 07 Feb. 2007), U.S. 60/702,746 filed 27 Jul. 2005, GB 0515461.2 filed 27 Jul. 2005 (published as GB2429096 14 Feb. 2007), U.S. 60/702,946 filed 27 Jul. 2005, GB 0515465.3 filed 27 Jul. 2005 (published as GB2429092 14 Feb. 2007), U.S. 60/702,897 filed 27 Jul. 2005, GB 0515463.8 filed 27 Jul. 2005 (published as GB2428948 07 Feb. 2007), U.S. 60/702,742 filed 27 Jul. 2005, GB 0515460.4 filed 27 Jul. 2005 (published as GB2429095 14 Feb. 2007), U.S. 60/702,732 filed 27 Jul. 2005, GB 0515462.0 filed 27 Jul. 2005 (published as GB2429097 14 Feb. 2007), U.S. 60/704,354 filed 27 Jul. 2005, GB 0518342.1 filed 08 Sep. 2005 (published as GB2429950 14 Mar. 2007), U.S. 60/715,044 filed 08 Sep. 2005, GB 0522037.1 filed 28 Oct. 2005 (published as GB2431759 02 May 2007), and U.S. 60/731,531 filed 28 Oct. 2005 (all invented by Cowburn et al.), the content of each and all of which is hereby incorporated hereinto by reference.

By way of illustration, a brief description of the method of operation of the Ingenia Technology Ltd system will now be presented.

FIG. 1 shows a schematic side view of a reader apparatus 1. The optical reader apparatus 1 is for measuring a signature from an article (not shown) arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing). The principal optical components are a laser source 14 for generating a coherent laser beam 15 and a detector arrangement 16 made up of a plurality of k photodetector elements, where k=2 in this example, labelled 16a and 16b. The laser beam 15 is focused by a focussing arrangement 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly 20. In the illustrated example, the detector elements 16a, 16b are distributed either side of the beam axis offset at different angles from the beam axis to collect light scattered in reflection from an article present in the reading volume. In one example, the offset angles are −30 and +50 degrees. The angles either side of the beam axis can be chosen so as not to be equal so that the data points they collect are as independent as possible. However, in practice, it has been determined that this is not essential to the operation and having detectors at equal angles either side of the incident beam is a perfectly workable arrangement. All four detector elements are arranged in a common plane. The photodetector elements 16a and 16b detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In one example, the depth of focus is approximately ±2 mm which is sufficiently large to produce good results. In other arrangements, the depth of focus may be greater or smaller. The parameters, of depth of focus, numerical aperture and working distance are interdependent, resulting in a well known trade off between spot size and depth of focus. In some arrangements, the focus may be adjustable and in conjunction with a rangefinding means the focus may be adjusted to target an article placed within an available focus range.

In order to enable a number of points on the target article to be read, the article and reader apparatus can be arranged so as to permit the incident beam and associated detectors to move relative to the target article. This can be arranged by moving the article, the scanner assembly or both. In some examples, the article may be held in place adjacent the reader apparatus housing and the scanner assembly may move within the reader apparatus to cause this movement. Alternatively, the article may be moved past the scanner assembly, for example in the case of a production line where an article moves past a fixed position scanner while the article travels along a conveyor. In other alternatives, both article and scanner may be kept stationary, while a directional focus means causes the coherent light beam to travel across the target. This may require the detectors to move with the light bean, or stationary detectors may be positioned so as to receive reflections from all incident positions of the light beam on the target.

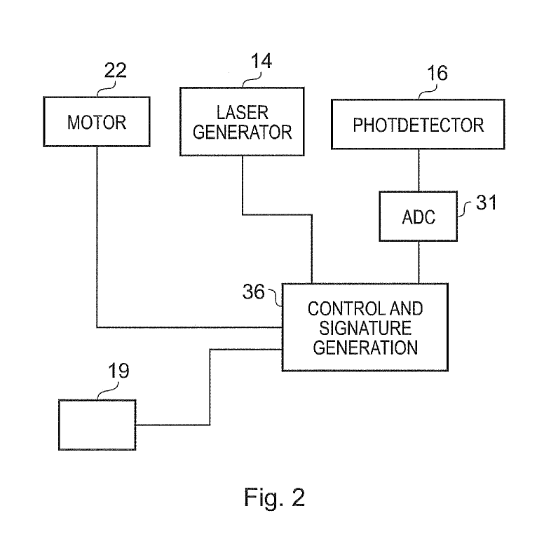

FIG. 2 is a block schematic diagram of logical components of a reader apparatus as discussed above. A laser generator 14 is controlled by a control and signature generation unit 36. Optionally, a motor 22 may also be controlled by the control and signature generation unit 36. Optionally, if some form of motion detection or linearization means (shown as 19) is implemented to measure motion of the target past the reader apparatus, and/or to measure and thus account for non-linearities in there relative movement, this can be controlled using the control and signature generation unit 36.

The reflections of the laser beam from the target surface scan area are detected by the photodetector 16. As discussed above, more than one photodetector may be provided in some examples. The output from the photodetector 16 is digitised by an analog to digital converter (ADC) 31 before being passed to the control and signature generation unit 36 for processing to create a signature for a particular target surface scan area. The ADC can be part of a data capture circuit, or it can be a separate unit, or it can be integrated into a microcontroller or microprocessor of the control and signature generation unit 36.

The control and signature generation unit 36 can use the laser beam present incidence location information to determine the scan area location for each set of photodetector reflection information. Thereby a signature based on all or selected parts of the scanned part of the scan area can be created. Where less than the entire scan area is being included in the signature, the signature generation unit 36 can simply ignore any data received from other parts of the scan area when generating the signature. Alternatively, where the data from the entire scan area is used for another purpose, such as positioning or gathering of image-type data from the target, the entire data set can be used by the control and signature generation unit 36 for that additional purpose and then kept or discarded following completion of that additional purpose.

As will be appreciated, the various logical elements depicted in FIG. 2 may be physically embodied in a variety of apparatus combinations. For example, in some situations, all of the elements may be included within a scan apparatus. In other situations, the scan apparatus may include only the laser generator 14, motor 22 (if any) and photodetector 16 with all the remaining elements being located in a separate physical unit or units. Other combinations of physical distribution of the logical elements can also be used. Also, the control and signature generation unit 36 may be split into separate physical units. For example, the there may be a first unit which actually controls the laser generator 14 and motor (if any), a second unit which calculates the laser beam current incidence location information, a third unit which identifies the scan data which is to be used for generating a signature, and a fourth part which actually calculates the signature.

It will be appreciated that some or all of the processing steps carried out by the ADC 31 and/or control and signature generation unit 36 may be carried out using a dedicated processing arrangement such as an application specific integrated circuit (ASIC) or a dedicated analog processing circuit. Alternatively or in addition, some or all of the processing steps carried out by the beam ADC 31 and/or control and signature generation unit 36 may be carried out using a programmable processing apparatus such as a digital signal processor or multi-purpose processor such as may be used in a conventional personal computer, portable computer, handheld computer (e.g. a personal digital assistant or PDA) or a smartphone. Where a programmable processing apparatus is used, it will be understood that a software program or programs may be used to cause the programmable apparatus to carry out the desired functions. Such software programs may be embodied onto a carrier medium such as a magnetic or optical disc or onto a signal for transmission over a data communications channel.

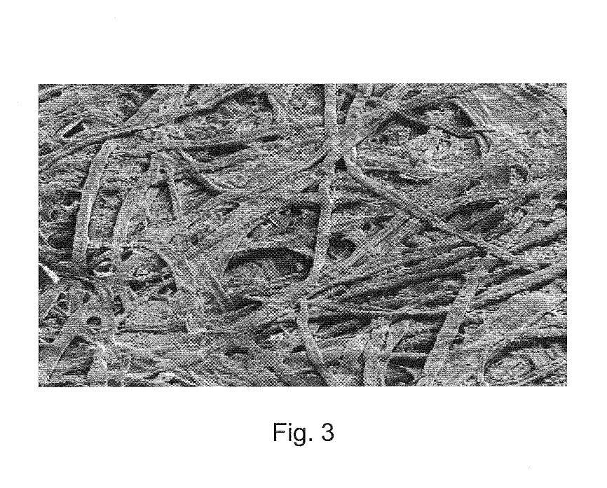

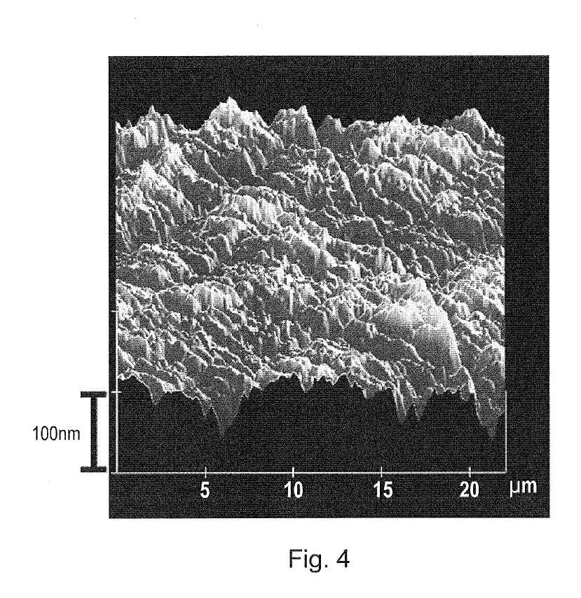

To illustrate the surface properties which the system of these examples can read, FIGS. 3 and 4 illustrate a paper and plastic article surface respectively.

FIG. 3 is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other plant-derived fibres that make up paper. The figure is also illustrative of the characteristic length scale for the wood fibres which is around 10 microns. This dimension has the correct relationship to the optical wavelength of the coherent beam to cause diffraction and also diffuse scattering which has a profile that depends upon the fibre orientation. It will thus be appreciated that if a reader is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

FIG. 4 shows an equivalent image for a plastic surface. This atomic force microscopy image clearly shows the uneven surface of the macroscopically smooth plastic surface. As can be surmised from the figure, this surface is smoother than the paper surface illustrated in FIG. 3, but even this level of surface undulation can be uniquely identified using the signature generation scheme of the present examples.

In other words, it is essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

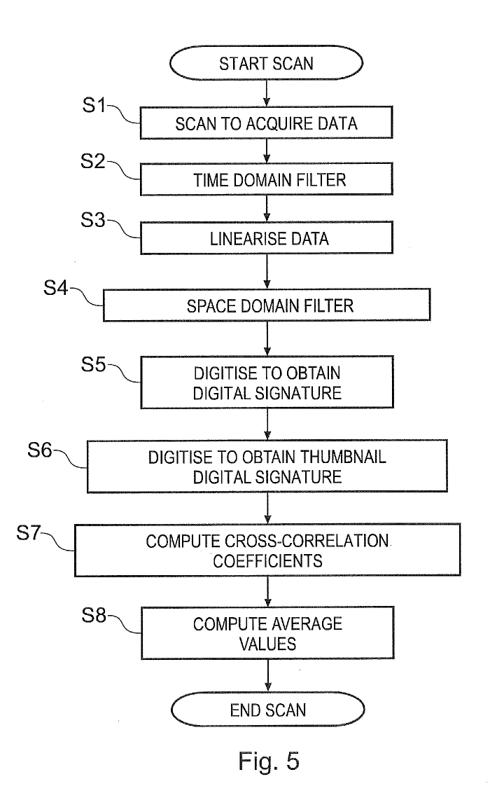

FIG. 5 shows a flow diagram showing how a signature of an article can be generated from a scan.

Step S1 is a data acquisition step during which the optical intensity at each of the photodetectors is acquired at a number of locations along the entire length of scan. Simultaneously, the encoder signal is acquired as a function of time. It is noted that if the scan motor has a high degree of linearisation accuracy (e.g. as would a stepper motor), or if non-linearities in the data can be removed through block-wise analysis or template matching, then linearisation of the data may not be required. Referring to FIG. 2 above, the data is acquired by the signature generator 36 taking data from the ADC 31. The number of data points per photodetector collected in each scan is defined as N in the following. Further, the value aₖ (i) is defined as the i-th stored intensity value from photodetector k, where i runs from 1 to N.

Step S2 is an optional step of applying a time-domain filter to the captured data. In the present example, this is used to selectively remove signals in the 50/60 Hz and 100/120 Hz bands such as might be expected to appear if the target is also subject to illumination from sources other than the coherent beam. These frequencies are those most commonly used for driving room lighting such as fluorescent lighting.

Step S3 performs alignment of the data. In some examples, this step uses numerical interpolation to locally expand and contract aₖ(i) so that the encoder transitions are evenly spaced in time. This corrects for local variations in the motor speed and other non-linearities in the data. This step can be performed by the signature generator 36.

In some examples, where the scan area corresponds to a predetermined pattern template, the captured data can be compared to the known template and translational and/or rotational adjustments applied to the captured data to align the data to the template. Also, stretching and contracting adjustments may be applied to the captured data to align it to the template in circumstances where passage of the scan head relative to the article differs from that from which the template was constructed. Thus if the template is constructed using a linear scan speed, the scan data can be adjusted to match the template if the scan data was conducted with non-linearities of speed present.

Step S4 applies a space-domain band-pass filter to the captured data. This filter passes a range of wavelengths in the x-direction (the direction of movement of the scan head). The filter is designed to maximise decay between samples and maintain a high number of degrees of freedom within the data. With this in mind, the lower limit of the filter passband is set to have a fast decay. This is required as the absolute intensity value from the target surface is uninteresting from the point of view of signature generation, whereas the variation between areas of apparently similar intensity is of interest. However, the decay is not set to be too fast, as doing so can reduce the randomness of the signal, thereby reducing the degrees of freedom in the captured data. The upper limit can be set high; whilst there may be some high frequency noise or a requirement for some averaging (smearing) between values in the x-direction (much as was discussed above for values in the y-direction), there is typically no need for anything other than a high upper limit. In some examples a 2^{nd} order filter can be used. In one example, where the speed of travel of the laser over the target surface is 20 mm per second, the filter may have an impulse rise distance 100 microns and an impulse fall distance of 500 microns.

Instead of applying a simple filter, it may be desirable to weight different parts of the filter. In one example, the weighting applied is substantial, such that a triangular passband is created to introduce the equivalent of realspace functions such as differentiation. A differentiation type effect may be useful for highly structured surfaces, as it can serve to attenuate correlated contributions (e.g. from surface printing on the target) from the signal relative to uncorrelated contributions.

Step S5 is a digitisation step where the multi-level digital signal (the processed output from the ADC) is converted to a bi-state digital signal to compute a digital signature representative of the scan. The digital signature is obtained in the present example by applying the rule: aₖ(i) >mean maps onto binary ‘1’ and aₖ(i) <=mean maps onto binary ‘0’. The digitised data set is defined as dₖ(i) where i runs from 1 to N. The signature of the article may advantageously incorporate further components in addition to the digitised signature of the intensity data just described. These further optional signature components are now described.

Step S6 is an optional step in which a smaller ‘thumbnail’ digital signature is created. In some examples, this can be a realspace thumbnail produced either by averaging together adjacent groups of m readings, or by picking every cth data point, where c is the compression factor of the thumbnail. The latter may be preferable since averaging may disproportionately amplify noise. In other examples, the thumbnail can be based on a Fast Fourier Transform of some or all of the signature data. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist (i.e. where k>1). The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients can be useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and a₁(i), where k≠1and k,1 vary across all of the photodetector channel numbers. The normalised cross-correlation function is defined as:

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background. The rms value provides an indication of the reflectivity of the surface, in that the rms value is related to the surface roughness.

The signature data obtained from scanning an article can be compared against records held in a signature database for verification purposes and/or written to the database to add a new record of the signature to extend the existing database and/or written to the article in encoded form for later verification with or without database access.

A new database record will include the digital signature obtained in Step S5 as well as optionally its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

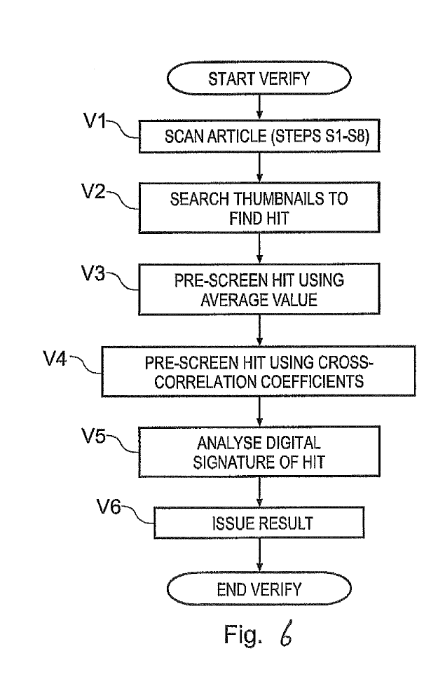

FIG. 6 is a flow diagram showing how a signature of an article obtained from a scan can be verified against a signature database.

In a simple implementation, the database could simply be searched to find a match based on the full set of signature data. However, to speed up the verification process, the process of the present example uses the smaller thumbnails and pre-screening based on the computed average values and cross-correlation coefficients as now described. To provide such a rapid verification process, the verification process is carried out in two main steps, first using the thumbnails derived from the amplitude component of the Fourier transform of the scan data (and optionally also pre-screening based on the computed average values and cross-correlation coefficients) as now described, and second by comparing the scanned and stored full digital signatures with each other.

Verification Step V1 is the first step of the verification process, which is to scan an article according to the process described above, i.e. to perform Scan Steps S1 to S8. This scan obtains a signature for an article which is to be validated against one or more records of existing article signatures Verification Step V2 seeks a candidate match using the thumbnail derived from the Fourier transform amplitude component of the scan signal, which is obtained as explained above with reference to Scan Step S6. Verification Step V2 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing. A variation on this would be to include the possibility of passing multiple candidate matches for full testing based on the full digital signature. The thumbnail selection can be based on any suitable criteria, such as passing up to a maximum number of, for example 10, candidate matches, each candidate match being defined as the thumbnails with greater than a certain threshold percentage of matching bits, for example 60%. In the case that there are more than the maximum number of candidate matches, only the best 10 are passed on. If no candidate match is found, the article is rejected (i.e. jump to Verification Step V6 and issue a fail result).

This thumbnail based searching method employed in the present example delivers an overall improved search speed, for the following reasons. As the thumbnail is smaller than the full signature, it takes less time to search using the thumbnail than using the full signature. Where a realspace thumbnail is used, the thumbnail needs to be bit-shifted against the stored thumbnails to determine whether a “hit” has occurred, in the same way that the full signature is bit-shifted against the stored signature to determine a match. The result of the thumbnail search is a shortlist of putative matches, each of which putative matches can then be used to test the full signature against.

Where the thumbnail is based on a Fourier Transform of the signature or part thereof, further advantages may be realised as there is no need to bit-shift the thumbnails during the search. A pseudo-random bit sequence, when Fourier transformed, carries some of the information in the amplitude spectrum and some in the phase spectrum. Any bit shift only affects the phase spectrum, however, and not the amplitude spectrum. Amplitude spectra can therefore be matched without any knowledge of the bit shift. Although some information is lost in discarding the phase spectrum, enough remains in order to obtain a rough match against the database. This allows one or more putative matches to the target to be located in the database. Each of these putative matches can then be compared properly using the conventional real-space method against the new scan as with the realspace thumbnail example.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. In the present example, a typical value for q is 4 and a typical value for k is in the range 1 to 2, making typically 4 to 8 bits per block. The qk bits are then matched against the qk corresponding bits in the stored digital signature dₖ^{db}(i+j). If the number of matching bits within the block is greater or equal to some pre-defined threshold zₜₕᵣₑₛₕ, then the number of matching blocks is incremented. A typical value for zₜₕᵣₑₛₕ is 7 on a two detector system. For a 1 detector system (k=1), zₜₕᵣₑₛₕ might typically have a value of 3. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of z_{threshold}), M is the number of matching blocks and p(M) is the probability of M or more blocks matching accidentally. The value of s is determined by comparing blocks within the database from scans of different objects of similar materials, e.g. a number of scans of paper documents etc. For the example case of q=4, k=2 and z_{threshold}=7, we find a typical value of s is 0.1. If the qk bits were entirely independent, then probability theory would give s=0.01 for z_{threshold}=7. The fact that we find a higher value empirically is because of correlations between the k detector channels (where multiple detectors are used) and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10^{-177.} As mentioned above, these figures apply to a four detector channel system. The same calculations can be applied to systems with other numbers of detector channels.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification. In experiments carried out upon paper, it has generally been found that 75% of bits in agreement represents a good or excellent match, whereas 50% of bits in agreement represents no match.

By way of example, it has been experimentally found that a database comprising 1 million records, with each record containing a 128-bit thumbnail of the Fourier transform amplitude spectrum, can be searched in 1.7 seconds on a standard PC computer of 2004 specification. 10 million entries can be searched in 17 seconds. High-end server computers can be expected to achieve speeds up to 10 times faster than this.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

In one alternative example, step V5 (calculation of the probability of an accidental match) can be performed using a method based on an estimate of the degrees of freedom in the system. For example, if one has a total of 2000 bits of data in which there are 1300 degrees of freedom, then a 75% (1500 bits) matching result is the same as 975 (1300×0.75) independent bits matching. The uniqueness is then derived from the number of effective bits as follows:

$$p ( m ) = {\sum }_{w = n - M}^{n} {{s}^{w} ( 1 - s )}^{n - w} {}_{w}^{n} C$$

This equation is identical to the one indicated above, except that here m is the number of matching bits and p(m) is the probability of m or more blocks matching accidentally.

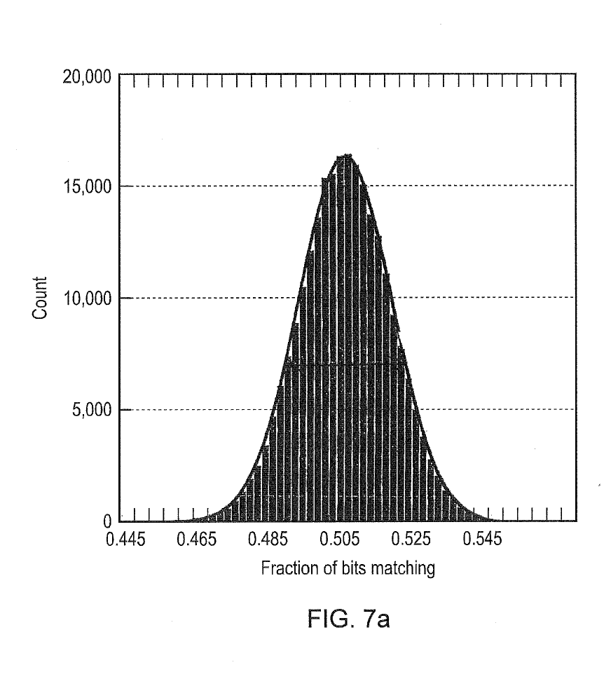

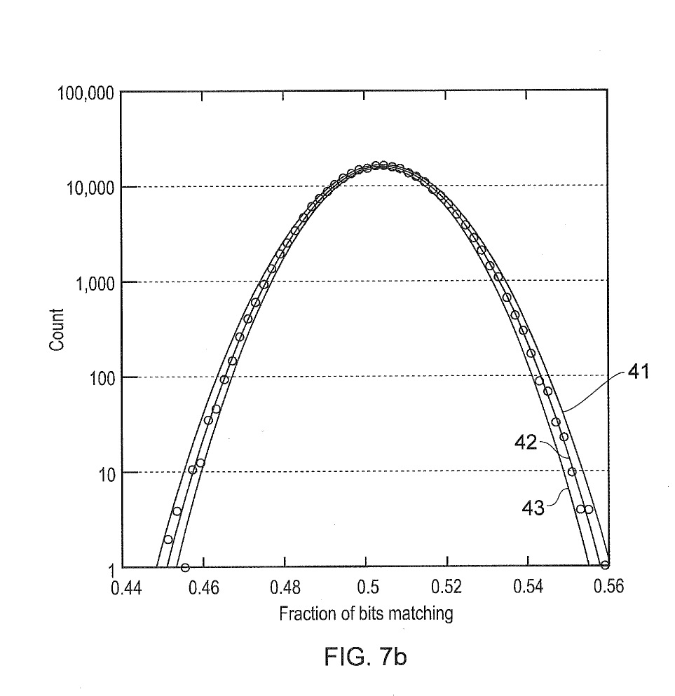

The number of degrees of freedom can be calculated for a given article type as follows. The number of effective bits can be estimated or measured. To measure the effective number of bits, a number of different articles of the given type are scanned and signatures calculated. All of the signatures are then compared to all of the other signatures and a fraction of bits matching result is obtained. An example of a histogram plot of such results is shown in FIG. 7a. The plot in FIG. 7a is based on 124,500 comparisons between 500 similar items, the signature for each item being based on 2000 data points. The plot represents the results obtained when different items were compared.

From FIG. 7a it can clearly be seen that the results provide a smooth curve centred around a fraction of bits matching result of approximately 0.5. For the data depicted in FIG. 7a, a curve can be fitted to the results, the mean y of which curve is 0.504 and the standard deviation ÿ of which is 0.01218. From the fraction of bits matching plot, the number of degrees of freedom N can be calculated as follows:

$$N = μ \frac{1 - μ}{{σ}^{2}}$$

In the context of the present example, this gives a number of degrees of freedom N of 1685.

The accuracy of this measure of the degrees of freedom is demonstrated in FIG. 7b. This figure shows three binomial curves plotted onto the experimental of fraction of bits matching. Curve 41 is a binomial curve with a turning point at 0.504 using N=1535, curve 42 is a binomial curve with a turning point at 0.504 using N=1685, and curve 43 is a binomial curve with a turning point at 0.504 using N=1835. It is clear from the plot that the curve 42 fits the experimental data, whereas curves 41 and 43 do not.

For some applications, it may be possible to make an estimate of the number of degrees of freedom rather than use empirical data to determine a value. If one uses a conservative estimate for an item, based on known results for other items made from the same or similar materials, then the system remains robust to false positives whilst maintaining robustness to false negatives.

FIG. 8 is a flow diagram showing the overall process of how a document is scanned for verification purposes and the results presented to a user. First the document is scanned according to the scanning steps of FIG. 5. The document authenticity is then verified using the verification steps of FIG. 6. If there is no matching record in the database, a “no match” result can be displayed to a user. If there is a match, this can be displayed to the user using a suitable user interface. The user interface may be a simple yes/no indicator system such as a lamp or LED which turns on/off or from one colour to another for different results. The user interface may also take the form of a point of sale type verification report interface, such as might be used for conventional verification of a credit card. The user interface might be a detailed interface giving various details of the nature of the result, such as the degree of certainty in the result and data describing the original article or that article's owner. Such an interface might be used by a system administrator or implementer to provide feedback on the working of the system. Such an interface might be provided as part of a software package for use on a conventional computer terminal.

It will thus be appreciated that when a database match is found a user can be presented with relevant information in an intuitive and accessible form which can also allow the user to apply his or her own common sense for an additional, informal layer of verification. For example, if the article is a document, any image of the document displayed on the user interface should look like the document presented to the verifying person, and other factors will be of interest such as the confidence level and bibliographic data relating to document origin. The verifying person will be able to apply their experience to make a value judgement as to whether these various pieces of information are self consistent.

On the other hand, the output of a scan verification operation may be fed into some form of automatic control system rather than to a human operator. The automatic control system will then have the output result available for use in operations relating to the article from which the verified (or non-verified) signature was taken.

Thus there have now been described methods for scanning an article to create a signature therefrom and for comparing a resulting scan to an earlier record signature of an article to determine whether the scanned article is the same as the article from which the record signature was taken. These methods can provide a determination of whether the article matches one from which a record scan has already been made to a very high degree of accuracy.

From one point of view, there has thus now been described, in summary, a system in which a digital signature is obtained by digitising a set of data points obtained by scanning a coherent beam over a paper, cardboard or other article, and measuring the scatter. A thumbnail digital signature is also determined, either in realspace by averaging or compressing the data, or by digitising an amplitude spectrum of a Fourier transform of the set of data points. A database of digital signatures and their thumbnails can thus be built up. The authenticity of an article can later be verified by re-scanning the article to determine its digital signature and thumbnail, and then searching the database for a match. Searching is done on the basis of the Fourier transform thumbnail to improve search speed. Speed is improved, since, in a pseudo-random bit sequence, any bit shift only affects the phase spectrum, and not the amplitude spectrum, of a Fourier transform represented in polar co-ordinates. The amplitude spectrum stored in the thumbnail can therefore be matched without any knowledge of the unknown bit shift caused by registry errors between the original scan and the re-scan.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a swipe-type scanner.

In some examples, where a scanner is based upon a scan head which moves within the scanner unit relative to an article held stationary against or in the scanner, then linearisation guidance can be provided within the scanner to address any non-linearities in the motion of the scan head. Where the article is moved by a human, these non-linearities can be greatly exaggerated

To address recognition problems which could be caused by these non-linear effects, it is possible to adjust the analysis phase of a scan of an article. Thus a modified validation procedure will now be described with reference to FIG. 44a. The process implemented in this example uses a block-wise analysis of the data to address the non-linearities.

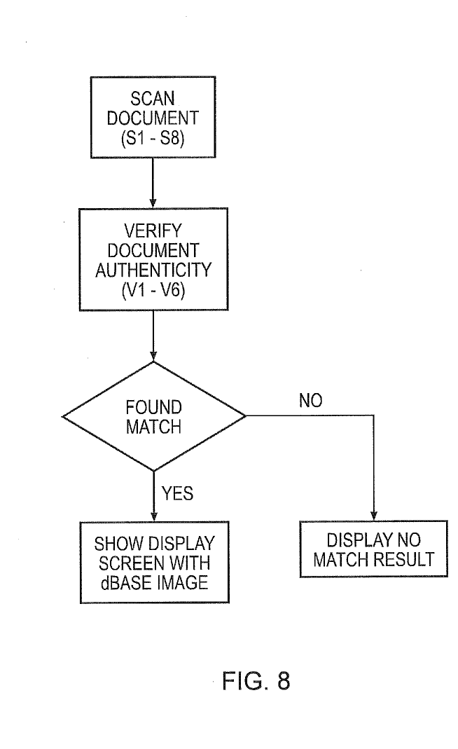

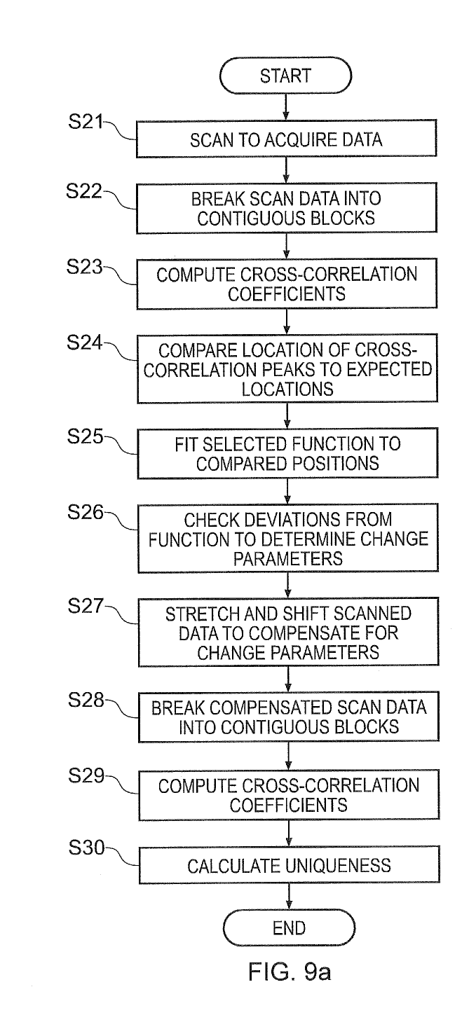

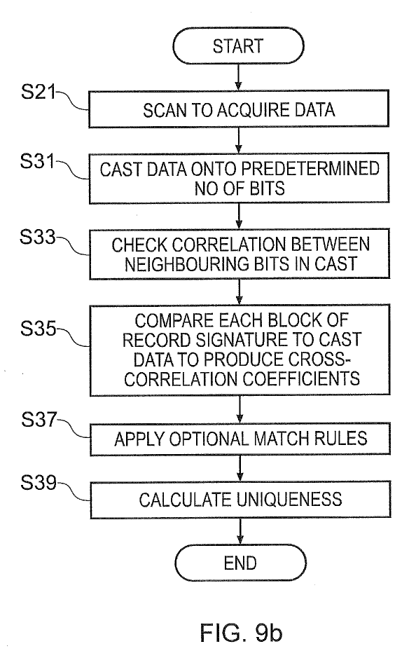

The process carried out in accordance with FIG. 9a can include some or all of the steps of time domain filtering, alternative or additional linearisation, space domain filtering, smoothing and differentiating the data, and digitisation for obtaining the signature and thumbnail described with reference to FIG. 6, but are not shown in FIG. 9a so as not to obscure the content of that figure.

As shown in FIG. 9a, the scanning process for a validation scan using a block-wise analysis starts at step S21 by performing a scan of the article to acquire the date describing the intrinsic properties of the article. This scanned data is then divided into contiguous blocks (which can be performed before or after digitisation and any smoothing/differentiation or the like) at step S22. In one example, a scan area of 1600 mm² (e.g. 40 mm×40 mm) is divided into eight equal length blocks. Each block therefore represents a subsection of the scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case where a perfectly linear relationship exists between the original and later scans of the article.

As this block-matching technique is a relatively computationally intensive process, in some examples its use may be restricted to use in combination with a thumbnail search such that the block-wise analysis is only applied to a shortlist of potential signature matches identified by the thumbnail search.

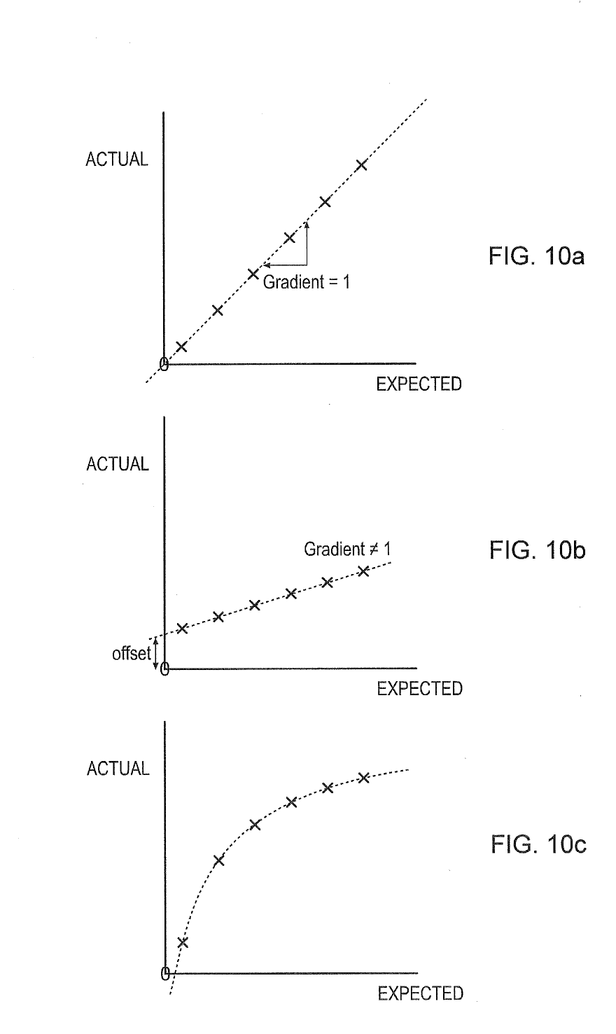

This relationship can be represented graphically as shown in FIGS. 10A, 10B and 10C. In the example of FIG. 10A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 10B, the cross-correlation peaks are closer together than expected, such that the gradient of a line of best fit is less than 1. Thus the article has shrunk relative to its physical characteristics upon initial scanning. Also, the best fit line does not pass through the origin of the plot. Thus the article is shifted relative to the scan head compared to its position for the record scan.

In the example of FIG. 10C, the cross correlation peaks do not form a straight line. In this example, they approximately fit to a curve representing a y² function. Thus the movement of the article relative to the scan head has slowed during the scan. Also, as the best fit curve does not cross the origin, it is clear that the article is shifted relative to its position for the record scan.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, x² functions and x³ functions.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and/or for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

An alternative method for performing a block-wise analysis of scan data is presented in FIG. 9b

This method starts at step S21 with performing a scan of the target surface as discussed above with reference to step S21 of FIG. 9a. Once the data has been captured, this scan data is cast onto a predetermined number of bits at step S31. This consists of an effective reduction in the number of bits of scan data to match the cast length. In the present example, the scan data is applied to the cast length by taking evenly spaced bits of the scan data in order to make up the cast data.

Next, step S33, a check is performed to ensure that there is a sufficiently high level of correlation between adjacent bits of the cast data. In practice, it has been found that correlation of around 50% between neighbouring bits is sufficient. If the bits are found not to meet the threshold, then the filter which casts the scan data is adjusted to give a different combination of bits in the cast data.

Once it has been determined that the correlation between neighbouring bits of the cast data is sufficiently high, the cast data is compared to the stored record signature at step S35. This is done by taking each predetermined block of the record signature and comparing it to the cast data. In the present example, the comparison is made between the cast data and an equivalent reduced data set for the record signature. Each block of the record signature is tested against every bit position offset of the cast data, and the position of best match for that block is the bit offset position which returns the highest cross-correlation value.

Once every block of the record signature has been compared to the cast data, a match result (bit match ratio) can be produced for that record signature as the sum of the highest cross-correlation values for each of the blocks. Further candidate record signatures can be compared to the cast data if necessary (depending in some examples upon whether the test is a 1:1 test or a 1:many test).

After the comparison step is completed, optional matching rules can be applied at step S37. These may include forcing the various blocks of the record signature to be in the correct order when producing the bit match ration for a given record signature. For example if the record signature is divided into five blocks (block 1, block 2, block 3, block 4 and block 5), but the best cross-correlation values for the blocks, when tested against the cast data returned a different order of blocks (e.g. block 2, block 3, block 4, block 1, block 5) this result could be rejected and a new total calculated using the best cross-correlation results that keep the blocks in the correct order. This step is optional as, in experimental tests carried out, it has been seen that this type of rule makes little if any difference to the end results. This is believed to be due to the surface identification property operating over the length of the shorter blocks such that, statistically, the possibility of a wrong-order match occurring to create a false positive is extremely low.

Finally, at step S39, using the bit match ratio, the uniqueness can be determined by comparing the whole of the scan data to the whole of the record signature, including shifting the blocks of the record signature against the scan data based on the position of the cross-correlation peaks determined in step S35. This time the magnitude of the cross-correlation peaks are analysed to determine the uniqueness factor at step S39. Thus it can be determined whether the scanned article is the same as the article which was scanned when the stored record signature was created

The block size used in this method can be determined in advance to provide for efficient matching and high reliability in the matching. When performing a cross-correlation between a scan data set and a record signature, there is an expectation that a match result will have a bit match ratio of around 0.9. A 1.0 match ratio is not expected due to the biometric-type nature of the property of the surface which is measured by the scan. It is also expected that a non-match will have a bit match ratio of around 0.5. The nature of the blocks as containing fewer bits than the complete signature tends to shift the likely value of the non-match result, leading to an increased chance of finding a false-positive. For example, it has been found by experiment that a block length of 32 bits moves the non-match to approximately 0.75, which is too high and too close to the positive match result at about 0.9 for many applications. Using a block length of 64 bits moves the non-match result down to approximately 0.68, which again may be too high in some applications. Further increasing the block size to 96 bits, shifts the non-match result down to approximately 0.6, which, for most applications, provides more than sufficient separation between the true positive and false positive outcomes. As is clear from the above, increasing the block length increases the separation between non-match and match results as the separation between the match and non-match peaks is a function of the block length. Thus it is clear that the block length can be increased for greater peak separation (and greater discrimination accuracy) at the expense of increased processing complexity caused by the greater number of bits per block. On the other hand, the block length may be made shorter, for lower processing complexity, if less separation between true positive and false positive outcomes is acceptable.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving licence or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

The area and elements selected for the scan area can depend upon a number of factors, including the element of the document which it is most likely that a fraudster would attempt to alter. For example, for any document including a photograph the most likely alteration target will usually be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof Damage or alteration in other regions may be ignored, thereby allowing the document to be recognised as authentic.

In some scanner apparatuses, it is also possible that it may be difficult to determine where a scanned region starts and finishes. Of the examples discussed above, this may be most problematic a processing line type system where the scanner may “see” more than the scan area for the article. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

In some examples, a drive motor of the processing line may be fitted with a rotary encoder to provide the speed of the article. This can be used to determine a start and stop position of the scan relative to a detected leading edge of the article. This can also be used to provide speed information for linearization of the data, as discussed above with reference to FIG. 5. The speed can be determined from the encoder periodically, such that the speed is checked once per day, once per hour, once per half hour etc.

In some examples the speed of the processing line can be determined from analysing the data output from the sensors. By knowing in advance the size of the article and by measuring the time which that article takes to pass the scanner, the average speed can be determined. This calculated speed can be used to both locate a scan area relative to the leading edge and to linearise the data, as discussed above with reference to FIG. 5.

Another method for addressing this type of situation is to use a marker or texture feature on the article to indicate the start and/or end of the scan area. This could be identified, for example using the pattern matching technique described above.

Thus there has now been described an number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

Thus an example of a system for obtaining and using a biometric-type signature from an article has been briefly described. For more details of this type of system, the reader is directed to consider the content of the various published patent applications identified above.

Biometric type signatures obtained from a study of the surface of an article, such as that described above, have advantages of high accuracy and security. However, such systems have the disadvantages of operating best when access to a record database is available, and requiring specialist equipment to perform a check. In many applications, these disadvantages are of no influence on the operational efficiency or on the attractiveness of implementing such a security system. However, one place where a suitable security checking scanner with access to a corporate article validity database is unlikely to be available is that of an individual consumer.

Therefore, in the following examples, there will be described a system and method for adding a further security layer to an article identification/validation system so as to enable authenticity checking to differing standards by different users/enforcement officers/consumers/vendors in the supply chain.

In many product supply industries, it is known to apply a unique identifier to each individual product. For example, many electronic devices have codes applied thereto indicating not just the manufacturer and model number, but also an individual item serial number. In another example, in the sale and supply of pharmaceutical compositions, such as medicines, prescription drugs and remedies, it is known to use a unique identifier on packaged pharmaceutical compositions. The unique identifier systems typically provide that for a particular composition from a given manufacturer, each package containing that composition has a unique number.

Such unique identifier systems enable manufacturers to track faulty/contaminated/ineffective/incorrect products both from the view of recalling products discovered to be in some way defective, and from the view of identifying a source plant/production line/worker of products discovered to be defective.

Unique identifier systems such as those briefly discussed above are generally cheap and easy to implement and allow comprehensive stock control facilities to manufacturers.

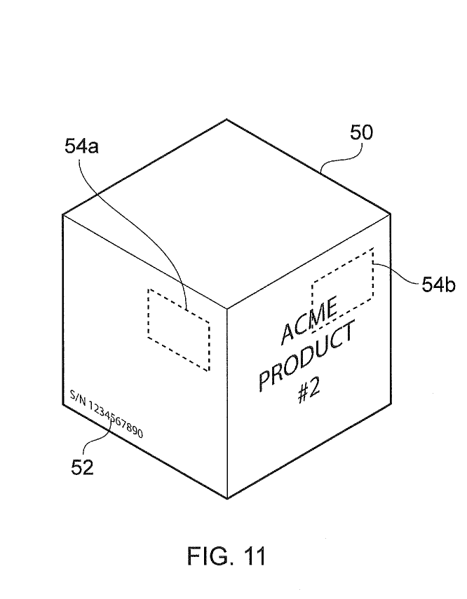

With reference to FIGS. 11 to 14, there will now be described examples of systems, apparatus and methods operable to present a two-tier authentication system for verification of articles to multiple standards by different categories of validation checkers.

FIG. 11 shows an example of an article 50 which can be authenticated and validated using the arrangements of the present examples. The article 50 depicted in FIG. 11 represents a generic article and could be any form of packaged or unpackaged product, any form of document or other paper or card article, or any form of plastic or metal identification, value or access card, for example. As shown in the figure, the article 50 has thereon an item number 52. Also shown in the figure are outline regions 54a and 54b. These outline regions indicate example parts of the article 50 upon which a surface analysis signature could be based. In the present example, these outline regions would not be marked on the article 50, but in other examples, an outline or other marker could be used to indicate the surface analysis signature region. As can be seen from FIG. 11, the first example outline region 54a is in an otherwise unremarkable area of the article 50. In contrast the second example outline region 54b overlaps a part of the printed text of the article 50.

The second tier authentication method, such as the one described above, may be termed “biometric” or “biometric-type” methods which create “biometric” or “biometric-type” signatures. Such signatures are typically created from intrinsic properties of the item, such as by surface analysis or internal feature analysis (typically of a translucent substrate) of the item.

Thus the article 50 can be recorded in an articles database referenced to both the item number 52 and a signature generated from one or more surface analysis signature regions 54. Having a database which contains both these forms of information for the article allows a comprehensive and flexible approach to not only tracking, but also authentication/verification.

The article item number 52 provides a first authentication/verification check. As each article has a unique number (unique within the scope of all outwardly similar items from a given source), a consumer/user/owner can relatively easily check (for example by telephoning a helpline or checking in an internet database) whether the item number of an item that they have bought or been offered for sale is a genuine item number. This provides first level of protection against counterfeit goods.

However, this system if used on its own has the drawback that a counterfeiter may be likely to produce a number of counterfeit articles each having the same item number as one genuine article. This means that a user/owner/purchaser of the article may be deceived into believing that the article is genuine, as the item number would appear on any lists/table/books etc of known item numbers.

However if, for example, a plurality of item owners were to contact a manufacturer or supplier in respect of the same item number, the manufacturer or supplier would be able quickly to establish that counterfeiting had taken place. At this stage it may be difficult for the manufacturer or supplier to establish which of the many articles bearing the same item number is the genuine one. The manufacturer or supplier may have to destructively test the articles in some way in order to determine which is the original, for example an electronic component may need to be checked within a glued closed housing, or a pharmaceutical composition may been to be subjected to laboratory analysis. Such checks, even if not destructive can be time consuming and expensive and while the checks are ongoing, the user/owner/purchaser may be without the article which it had used/owned/purchased.

Therefore, in the present example, a second tier of authentication can be used. By having data describing a signature based on the surface of a part of the article or its packaging stored by the supplier/manufacturer in advance in connection with the item number, if multiple articles each bearing the same item number are presented for authentication/verification as to genuineness it is possible to quickly and inexpensively determine which article is the genuine one. This process can be very user/owner/purchaser friendly in that the article may not need to be returned to the supplier/manufacturer for testing. Instead the article need only be presented to a suitable reader for a signature to be taken, and the signature then forwarded to the supplier/manufacturer. The reader may be something that a local trading standards office could maintain for consumer use. Likewise other public or private organisations such as the police, local governments, a Citizens Advice Bureau, or a retail outlet could maintain a scanner for authentication checking. Thus an article user/owner/consumer could present the article for authentication at the reader and a signature could be generated therefrom and sent to the manufacturer/supplier. A validation result could then be supplied to the user/owner/consumer either via the scanner operator or direct from the manufacturer/supplier.

This approach can also be used by customs, trading standards, counterfeit interception or similar personnel to inspect goods in transit or storage. The enforcement personnel could perform a very quick check of article item numbers against a list of valid item numbers to determine very quickly whether articles are genuine or not. If there were any query or suspicion, or as a matter of course, at least some articles could also be checked using the higher reliability signature method, with results on validity available instantly or after a delay. In some examples it may be desirable to provide a validation result only after enforcement personnel only after those personnel have departed from a warehouse or shipping vessel so as to avoid a personal risk to the safety of the enforcement personnel.

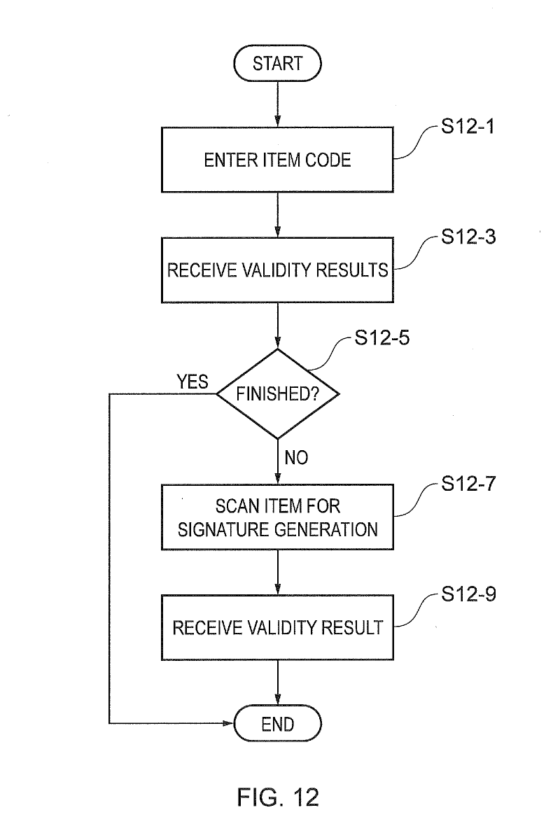

A flow chart detailing the steps that can be performed from a user point of view using the two tier validation process of the present examples is shown in FIG. 12. This clearly shows the two-tier approach of the present examples.

First, at step S12-1, the user enters an item code for an item to be verified/authenticated into a checking interface. This may be done, for example, by manually entering a numerical or alphanumeric code or by scanning a barcode on the item with a barcode scanner. Subsequently, at step S12-3, the user then receives a validation result from the checking interface. This validity result indicates whether or not the item code is an item code which has been issued in respect of an item. Depending upon the nature of the interface, the user may enter more information such as item manufacturer, item branding details, item type etc so as to enable the returned result to be specific to items meeting those details, thereby providing a more detailed result.

At this stage, a user may have finished with the validation process, or this may represent a sufficiently good validation result for a further service to be provided such as access to product support or recall information from a n item supplier. Thus, at this stage decision point S12-5 is used to determine whether the process is complete. If so, then the process ends, and if not the second tier of authentication is started at step S12-7.

At step S12-7, the user then scans the item to enable generation of a signature for the article. This signature generation can be performed as described with reference to FIG. 5 above.

As step S12-9, the user receives the validation result based upon the biometric-type scan. The validation result can be performed as described with reference to FIGS. 6 or 9 above.

From a user perspective the validation process is now complete. The validation result may be the end of the process, or may be fed into another system or query or consideration depending upon the user's requirements. Once this second tier validation result has been achieved, it could be used, for example, to determine whether or not to seize a shipment as being counterfeit, or to determine whether an article owner is entitled to some service.

Thus, even from this relatively simple viewpoint, the operation of the two tier system is apparent.

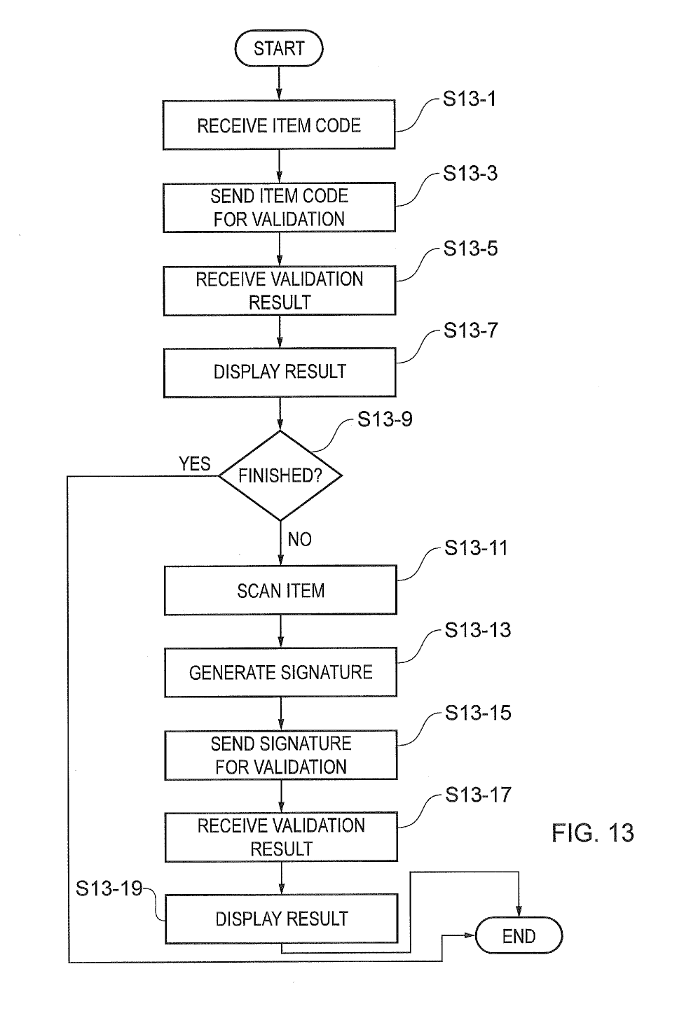

A flow chart detailing the steps that can be performed from a user terminal point of view using the two tier validation process of the present examples is shown in FIG. 13.

Starting at step S13-1, the user terminal receives an item code for an item to be verified. The item code may be received by way of, for example, manual input of a numeric or alphanumeric code by a user, or by electronic input of a code such as by scanning of a barcode which is encoded with the number. The item number is then sent for validation at step S13-3 and a validation result is subsequently received at step S13-7. The actual validation process may be carried out by another thread, process, program or function within the terminal apparatus (for example against a stored database) or may be carried out at a remote apparatus such as a database search server. Data communication between the user terminal and any such remote apparatus may be over a dedicated private link such as a direct cable connection, or over a public or private network (i.e. a many to many interconnect fabric) and in such an environment one or more of a virtual private network and individual payload encryption may be used to protect the data communications from interception and tampering.

Once the validation result is received by the user terminal, the result is displayed to a user in some way at step S13-7. This display may be in the form of a direct valid/invalid display (such as a message appearing on a screen or one or more lamps being illuminated, or even an audio “display” where noises are played to a user dependent upon the result. The display may also be indirect in the sense that a user may be allowed to proceed to a further process or be given access to some data, rather than receive an immediate “valid/invalid” result.

At this stage, a user may have finished with the validation process, or this may represent a sufficiently good validation result for a further service to be provided such as access to product support or recall information from a n item suppliers Thus, at this stage decision point S13-9 is used to determine whether the process is complete. If so, then the process ends, and if not the second tier of authentication is started at step S13-11.

At step S13-11 the user terminal scans the item. This scanning may be of the type discussed above with respect to FIGS. 1 to 5. The scan apparatus may be integral to the user terminal or may be connected thereto by some form of data link such as a cable or wireless data link. Then at step S13-13 a signature for the item is generated from the scan data, this may be performed in the manner described above with reference to FIG. 5. Some or all of the signature generation may be carried out by a dedicated scanner apparatus connected to the user terminal as discussed above.

Once the signature is generated, it is sent (at step S13-15) for validation sent for validation and a validation result is subsequently received at step S13-17. The actual validation process may be carried out by another thread, process, program or function within the terminal apparatus (for example against a stored database) or may be carried out at a remote apparatus such as a database search server. Data communication between the user terminal and any such remote apparatus may be over a dedicated private link such as a direct cable connection, or over a public or private network (i.e. a many to many interconnect fabric) and in such an environment one or more of a virtual private network and individual payload encryption may be used to protect the data communications from interception and tampering. In some instances, the item code may be sent with the signature to aid in the validation process. In particular an item code may be used to find, within a validation database, a previous signature taken from the article having that item code, which signature can then be one-to-one compared to the signature taken from the article for verification purposes. Thus the validation process may be made rapid by avoiding a need to perform a one-to-many search through a signature database using the signature itself, which search is almost inevitably slower than searching based on an item code as the item code search will be based on an exact match search, whereas the signature search will be based on a fuzzy match search.

Once the validation result has been received, it is displayed to a user at step S13-19. This display may be in the form of a direct valid/invalid display (such as a message appearing on a screen or one or more lamps being illuminated, or even an audio “display” where noises are played to a user dependent upon the result. The display may also be indirect in the sense that a user may be allowed to proceed to a further process or be given access to some data, rather than receive an immediate “valid/invalid” result.

Thus it is clear how the two stage validation process of the present examples works in the context of a user terminal configured to enable a user to utilise the two tier verification of the present examples.

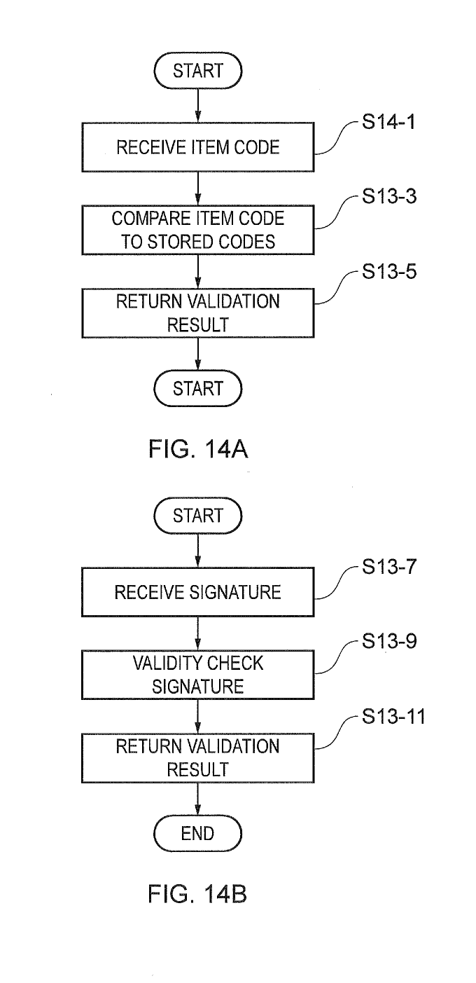

A flow chart detailing the steps that can be performed from a server point of view using the two tier validation process of the present examples is shown in FIG. 14.

To represent the fact that the databases for the item code validation and signature validation may be held and/or searched by different entities, FIG. 14 is split into parts A and B to show the steps associated with each security tier separately.

Thus, commencing at step S14-1, a validation process receives an item code for validation. This item code is then compared to a database of known valid codes at step S14-3 to determine whether the received item code is valid. As discussed above, this item code validation step may be a comparison between the received code and a list of known valid codes. In some examples more information, such as product code, product name, or model name/type may be provided to reduce the number of valid item codes than need to be searched through to determine a validity result. The result of this checking is then returned at step S14-5.

Thus the item code (first tier) validity checking is complete. If second tier checking is required, then the steps of FIG. 14B will be performed. As noted above, the steps of FIGS. 14A and 14B may be performed at or by the same apparatus or by different apparatus.

At step S14-7, a validation process receives a signature for validation. As noted above this may include the item code, or in the case where the same entity performs the steps of both FIGS. 14A and 14B, the signature query may be linked by some form of query identifier to link the signature to the previously provided for validation. If the item code is available as well as the signature, the search stage of the validation process (step S14-9) can be simplified as discussed above. At step S14-9, the signature is subjected to validation checking. This may take the form of the type of processing discussed with reference to FIGS. 6 and 9 above. The validation result is then returned at step S14-11.

Thus there has now been described, from three perspectives, a two tier verification and/or authentication system usable on very many different types of item. The skilled reader will appreciate the significant technical advantages provided by the arrangements and underlying concepts of the present examples.

Further examples and modifications of the methods and apparatus of the above-described examples will now be presented.

According to some examples, an “offline” working mode may be provided wherein the entirety of the two-tier authentication can be provided by authentication equipment not having a data connection to a central database system.

To enable this arrangement, an authentication apparatus may have stored therein a list of all valid item codes for a predetermined set of items. As such a list may typically be a simple text list or look-up table, the storage of such a list should require a economical and portable amount of storage memory in the authentication equipment. Also, searching for an exact match through such a list or table is very economical in terms of processor requirement and so an authentication equipment capable of performing such a search on a realistic and viable timescale for real-world usage would be expected to be economical and portable.

To perform the second tier authentication, two options could be adopted. The first would be to store a database of record signatures in the authentication equipment, and provide for the search to be carried out therein. This option would be most viable in the circumstance discussed above where each item code has a biometric-type signature associated therewith, so as to provide that the authentication equipment would not need to carry out a processing intensive one-to-many search for a fuzzy match between biometric-type signatures. This approach could have a commercial disadvantage that an item supplier/producer/manufacturer may not wish for the central database of authentic signatures to be distributed in this manner.

The second option would be to encode the signature for the item onto the item in some way. One example would be to use a barcode or similar printed onto the item after taking a record scan to create a record signature. In other words, the barcode can be originally applied at a time of manufacture of the item by scanning a signature generation area of the item, generating a signature therefrom and printing the barcode carrying the signature onto the item. The item would thus be labelled with a biometric-signature type characteristic of its intrinsic structure.

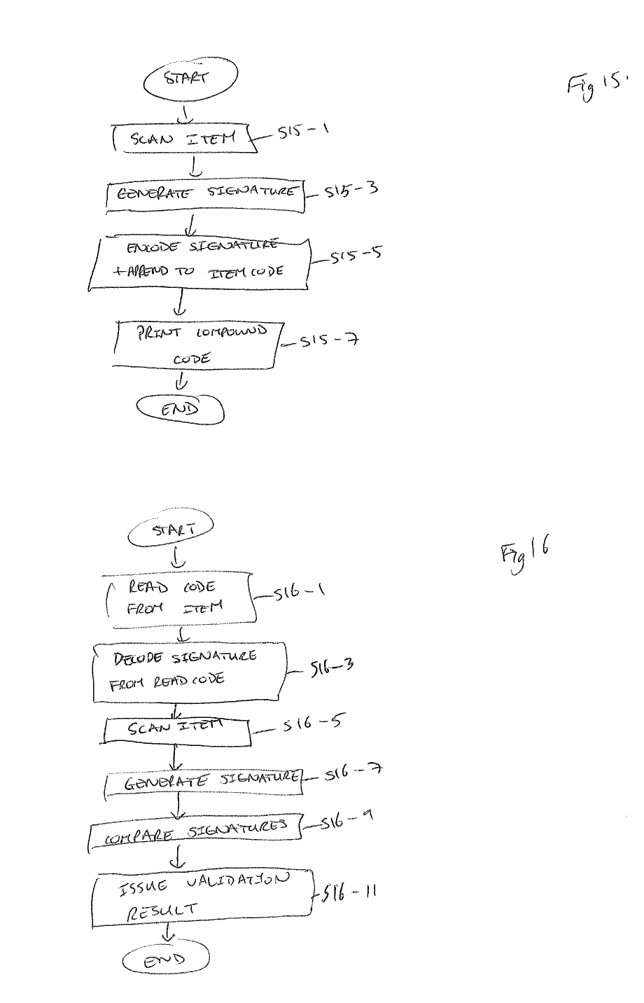

Examples of how such a system can be implemented are shown in FIGS. 15-17. In this example, the item is scanner prior to application of an item barcode, such as a barcode of the type which can be used as the item code in the examples of FIGS. 12 to 14 described above. The scan is taken from an area of the item onto which the code is to be applied and then the code is then supplemented by an encoded form of the signature before being printed onto the item.

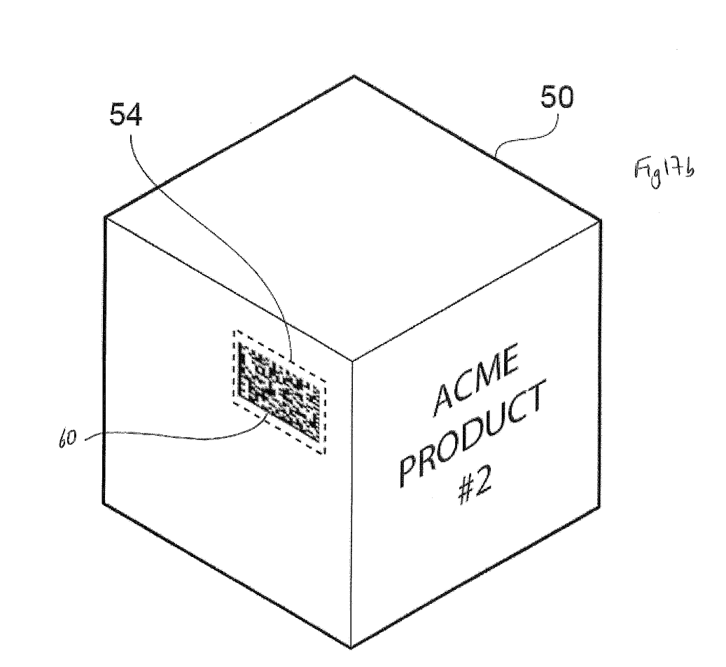

The process for applying a code to the article is illustrated in FIG. 15. reference is also made to FIGS. 17a and 17b. Starting at step S15-1, the item 50 is scanned at a scan area 54, from which a signature is generated at step S15-3. This signature generation can be performed as described with reference to FIG. 5 above.

The signature is then encoded into a 2-d barcode and consolidated with the 2-d barcode which makes up the item code at step S15-5. The compound barcode is then printed at step S15-7 into or onto the scan area 54 as illustrated by printed 2-d barcode 60 in FIG. 17b. Thus an item marked with its own signature in a form encoded as part of an applied item code for the item can be provided.

Although FIGS. 17a and 17b show the item as a 3-d item before and after code application, if the item is one which is produced from 2-d items such as a web or kit of panels, the scanning and printing can be performed before the article is assembled into 3-d form.

By combining the barcode location with the scan area location, co-location of the two security elements provides a further interrelation therebetween. For example, it is impossible for the scan area to be damaged or tampered with without also tampering with or damaging the barcode. Also, any attempt to tamper with the barcode would be likely to damage or disrupt the surface in the scan area. Additionally, simply copying the barcode onto a different article would result in a valid barcode part which represents the item code, but an invalid barcode part which represents the signature. As will be appreciated, the scan area need not have an exact 1:1 relationship with the code area in order to operate in this manner, for example one area may be a sub-area of the other, or the areas may overlap.

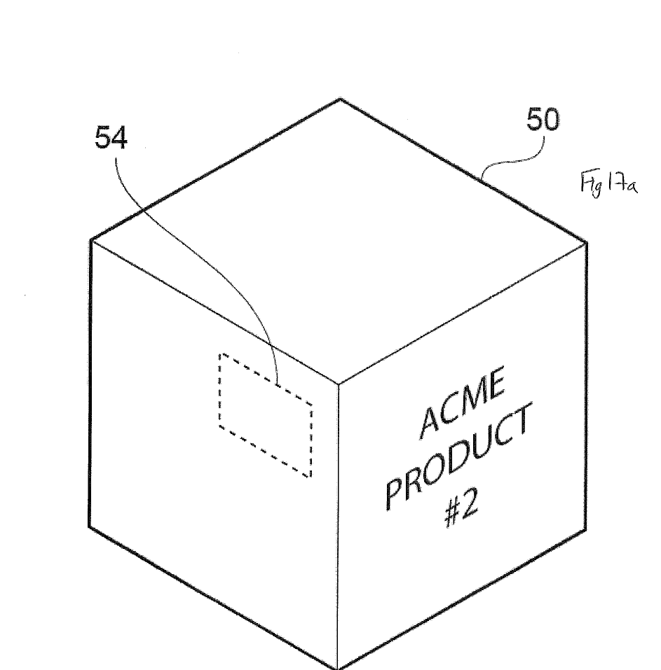

With reference to FIG. 16, a verification process can be carried out by reading the barcode from the item at step S16-1 and decoding the signature from the read code at step S16-3. The item can be scanned at step S16-5 and a signature be generated from the scan data at S16-7. It will be appreciated that the ordering of steps S16-1 though S16-7 can be changed to suit the particular implementation. S16-3 needs to be after S16-1 and S16-7 needs to be after S16=5, but outside of these restrictions, the ordering can be freely changed.

Once both scan signature has been generated and the encoded signature decoded, the two signatures can be compared at step S16-9 to determine a confidence as to whether both signatures were generated from the same item. The approach discussed above with reference to FIG. 6. Based upon the determined confidence, a validation result can be issued at step S16-11.

Thus it will be understood how a verification of an item can be performed using a code written to the item to avoid a need for database access. It will also be understood that the steps discussed with reference to FIG. 16 may be used in the context of the above example of FIG. 13. Specifically, the steps of FIG. 16 may be used to replace (or supplement) steps S13-11 through S13-19. In the case of replacement of the database check with the encoded signature check, then the second tier of authentication is provided by the encoded signature check. In the case of supplementing the database check with the encoded signature check, then the second tier of authentication is provided by the encoded signature check and the remote database check would be a third tier of authentication. In such an example, the third tier could be used periodically to ensure that the encoding used to encode the signature into the applied code on the item has not been cracked by a forger by ensuring that the encoded signature matches a database signature. Additional possibilities for such arrangements are discussed below.

Arrangements which use such an “off-line” verification against a written form of the signature on the article have application in a number of fields. In particular, where an item is such that it would ordinarily be marked with an item code in any case, the implementation of the “off-line” recording of the signature onto the item may be used without the casual observer of the item being aware that a greater than normal level of security is being used. For example, many pharmaceutical products are marked with an item code, often in the form of a 2D barcode to provide the tracking and authentication benefits associated with such marking. Supplementing the item code with an encoded form of the signature would provide for a second tier of authentication without the need to add any separate coding to the pharmaceutical product and without the need to always authenticate to a database. This would allow use of a higher level of authentication tracking (invisible or hard to notice to a potential counterfeiter) and would enable counterfeit checking to take place in locations where no database can be accessed.

It is noted that the barcode may itself be used for linearization of the scan as discussed above with reference to FIG. 5. This may be especially useful if the reader in the authentication equipment has a drive with poor linearity, such as a roller drive of the kind used in automated telling machines (ATMs) for example. The barcode can also optionally be used for positioning and/or alignment of an authentication equipment to the scan area, thereby providing that the verification scan is taken from the correct area of the item at the correct alignment.

It will be appreciated that this approach can be used to mark a wide variety of articles with a label that encodes the articles own signature obtained from its intrinsic physical properties, for example any printable article, including paper or cardboard articles or plastic articles.

Given the public nature of the barcode or other label that follows a publicly known encoding protocol, it may be advisable to make sure that the signature has been transformed using an asymmetric encryption algorithm for creation of the barcode, i.e. a one-way function is used, such as according to the well known RSA algorithm. Alternatively, the encryption could be symmetric. In this case the key could be held securely in tamper-proof memory or crypto-processor smart cards on the authentication equipment.

By reading the barcode and extracting the record signature therefrom, the authentication equipment can be used to check a signature generated from the item by the authentication equipment against the record signature and thus verify the authenticity of the item. This system would therefore defeat a counterfeiter that simply copied the item including the item code and signature as, although this would create an item having a known item code, the signature embodied in the barcode would necessarily differ substantially from any signature created from the counterfeit item.

In some examples, a record signature can be encoded to an item using an electronic or magnetic storage device in place of or additionally to the visible printing method described above. A magnetic strip of the type commonly used on bank cards can be used to carry data such as an encoded record signature. Also, an electronic device such as a “smart-card” type chip or an RFID unit could be used to store the encoded record signature.

Thus it is clear that a number of options exist for a fully “offline” two tier authentication system, thereby allowing a user of authentication equipment having no active data connection to a central database to verify the authenticity of an item without a requirement to wait until a central database can be contacted.

In some examples, it may be desired to combine the online and offline modes of operation. First, and as mentioned above, the system could use a local (i.e. offline) database of item codes and then use a remote database (i.e. online) check for the biometric signature. Secondly, a system can be implemented where an online mode of operation is the default or primary mode of operation, but in the event of a failure in a data connection to a remote database or server, an offline mode can be used where items to be authenticated include an encoded signature. In a third example, the system could be used in a default or primary offline mode, but having pre-set circumstances where an online mode is triggered for greater verification reliability. For example, if a particular item code is known or suspected to be the subject of counterfeit products, a second tier verification against a central database could be required in place of a second tier check against a locally held record signature. This effectively could be considered a three tier system. Alternatively, it could be the case that a particular encoding regime for locally stored record signatures becomes known to have been compromised, such that any locally stored record signature using the compromised encoding scheme could be automatically refused an authenticity result unless a check against a central database returned a positive result.

In some examples, it may be desirable to choose only one of the two tiers for each authenticity check. It has already been discussed above that using only first tier might be sufficient in some cases. On the other hand, it may be the case that the first tier is of no relevance or assistance in some forms of verification, so a user or user device could determine to miss out the first tier check and to use only the second tier check (the biometric signature).

Although it has been described above that checks against the first and second tiers are performed sequentially, this is not essential. In particular, in a circumstance where it is known in advance both tiers are to be used, the checks can be performed simultaneously. This is most applicable to the situation discussed above where the item code is to be used as an index for a database of record signatures. In this situation, it can be useful to have the item code and checking signature available at the same time so as to minimise search queries in the record signature database.

The use of the two tiers can be varied according to, not only authenticity level required for a given access/service/product or user level/purpose but also to, an alterable variable in relation to a given item or group of items. For example, if a given item code is known or suspected to have been the subject of counterfeiting, the item code entry in the item code list/table/database may be marked to indicate that this item code requires second tier authentication even for actions/services that ordinarily would only require first tier authentication. This then enables security checking levels to be adjusted to take account of known actions of criminals and/or counterfeiters.

As mentioned above, a unique identifier system can be used for tracking purposes. Using such a system, it is possible to track an item marked with a unique identifier in terms of its progress from production to packaging, and via all shipping stages. Thereby it is possible to trace any faults, damage or other imperfections in an article under analysis. The tracking can be performed by or on behalf of, for example, a manufacturer, a supplier, a sales outlet or a regulatory authority.

The above-described combination of such a unique identifier system with a biometric type identification can also be applied to a tracking or tracing arrangement as well. Items marked with a unique identifier can be recorded in a database or other record system and have entries therein which identify details of its manufacture location/date, packaging location/date and distribution path etc.

In particular, one known problem with the unique identifier systems outlined above is that it may be possible to remove the unique identifier from an item's packaging so as to make it difficult or impossible to trace its origin. This is a particular issue in the control of so-called “grey market” goods, where licensed/authorised goods are moved from a licensed/authorised market to a non-licensed/authorised market for sale or disposal.

If a unique identifier is removed from an article, then the history of that article may be considered lost as it is no longer possible to trace the manufacture line, distribution centres etc that the item has come from or via. This enables a grey market trader to sell the item without the element(s) of the supply chain that allowed the item to enter the grey market to be identified. Also, without the unique identifier, it is harder for a consumer to tell whether the product is in fact genuine or fake.

Thus, an example arrangement for use of the biometric-type signature system as discussed above, in combination with a unique identifier type system is now described.

According to the present example, an article can include both a unique identifier and a region from which a biometric-type signature is derived in the manner discussed with respect to FIG. 11 above. When such an article is examined, either or both of the unique identifier and the biometric-type signature can be used not only for authentication, as described above, but also or instead for tracking the item. By comparison of the item details (identifier or biometric) to a database or other record system, information describing the tracking history of the article can be retrieved. Thus, for any given article, any or all of details in respect of the history of the article, including, for example, manufacturing line, manufacture date, packaging line, packaging date, distribution centres passed through, and carrier details.

If, however the unique identified has been removed or defaced so as to make it unintelligible (either accidentally or deliberately), the unique identifier itself cannot be used to perform this track/trace function. However, if, as has been described above, the biometric signature and the unique identifier are both stored within a database of articles in association with the particular article, the biometric signature can be used to retrieve the unique identifier and/or the item history. This enables the tracking history to be retrieved to enable a meaningful assessment of the item to be made.

The uses for this system are many and varied. Examples include tracing the history of a grey market item so as to identify the party or parties responsible for the item ending up on the grey market. Also, quality control and recall systems are enabled—both from the point of view of finding recalled items that have lost their unique identifier for any reason, and from the point of view of being able to identify if a group of defective items have originated from or passed through a common point to as to be able to identify a source of defects.

As will be appreciated the dual aspects to the described systems, of authentication and tracking, lead to the systems having a great deal of flexibility and to their providing significant benefit to deployers.

Thus there have been described a number of examples of systems, apparatuses and methods for implementation of a two (or more)-tier authenticity/verification system. The skilled reader will appreciate that the present invention includes aspects and embodiments of the concepts included in the disclosure. Furthermore, the skilled reader will appreciate that the present disclosure includes features and their equivalents not explicitly disclosed herein or enumerated in the appended claims. The features of the appended claims may be combined in any manner deemed applicable by the skilled reader, and not merely according the claim dependencies explicitly recited.

1. A method of preparing an article for later verification, the method comprising:
generating a biometric type signature for an article from analysis of intrinsic surface or internal structure thereof;
combining the biometric type signature for the article with an identifier code for the article; and
applying the combined code to a part of the article from which the biometric type signature was generated.

2. The method of claim 1, further comprising encoding the biometric type signature before the combining.

3. The method of claim 1, wherein the combined code is a barcode.

4. The method of claim 1, wherein the article is a pharmaceutical product or pharmaceutical product packaging.

5. The method of claim 1, wherein the generating comprises: directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points.

6. The method of claim 1, further comprising storing the biometric type signature in a database.

7. The method of claim 6, wherein the storing further comprises associating the biometric type signature record in the database with the identifier code for the article.

8. The method of claim 1, wherein in a later verification, a result can be determined from one or both of the identifier code and the biometric type signature, in accordance with a desired result authentication certainty level.

9. The method of claim 1, wherein the identifier code for the article is assigned to the article according to the unique identity or group identify of the article to enable identification of the article distinct from other similar articles.

10. A method of validating the authenticity of an article, the method comprising:
reading an assigned code from an article;
extracting from the assigned code an identifier for the article;
extracting from the assigned code a biometric type signature for the article;
using the identifier as a first authentication method to determine the authenticity of the article by comparing the extracted identifier to a record of one or more valid identifiers; and
using the biometric type signature as a second authentication method to determine the authenticity of the article by comparing the extracted biometric type signature to a biometric type signature generated from analysis of intrinsic surface or internal structure of an area of the article from where the applied code is read.

11. The method of claim 10, wherein the extracting a biometric type signature comprises decoding the biometric type signature from the assigned code or a part thereof.

12. The method of claim 10, wherein the combined code is a barcode.

13. The method of claim 10, wherein the article is a pharmaceutical product or pharmaceutical product packaging.

14. The method of claim 10, wherein the biometric type signature is generated by:
directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points.

15. The method of claim 10, further comprising using the biometric type signature as a third authentication method by comparing the biometric type signature generated from analysis of intrinsic surface or internal structure of an area of the article from where the applied code is read to a biometric type signature retrieved from a database.

16. The method of claim 15, wherein the biometric type signature retrieved from the database is retrieved by using the identifier code for the article as a search term.

17. The method of claim 15, comprising selectively using the third authentication method for less than all articles subjected to the method, wherein articles are selected for use of the third authentication method in accordance with one or more of: a random selection, a maximum number of articles interval, a perceived damage to the applied code, and an encoding protocol or signature used to encode the biometric type signature in the applied code.

18. The method of claim 10, wherein an authentication result can be determined from one or both of the first and second authentication methods, in accordance with a desired result authentication certainty level.

19. The method of claim 18, wherein the desired result authentication certainty level is predetermined in accordance with one or more of an intended use of the article, the nature of the article, a service entitlement provided by the article, an access entitlement provided by the article, the value of the article or a rights level of an operator.

20. The method of claim 18, wherein the desired result authentication certainty level is adjusted following receipt of an authenticity result from the first authentication method.

21. The method of claim 10, wherein the identifier code for the article is assigned to the article according to the unique identity or group identify of the article to enable identification of the article distinct from other similar articles.

22. Apparatus for preparing an article for later verification, the apparatus comprising:
a scanning unit operable to scan an article to perform analysis of intrinsic surface or internal structure thereof
a processing unit operable to generate a biometric type signature for an article from data gathered by the scanning unit;
a processing unit operable to combine the biometric type signature for the article with an identifier code for the article; and
a printing unit operable to apply the combined code to a part of the article scanned by the scanning unit.

23. The apparatus of claim 22, further comprising a processing unit operable to encode the biometric type signature before combining with the identifier code.

24. The apparatus of claim 22, wherein the combined code is a barcode.

25. The apparatus of claim 22, wherein the article is a pharmaceutical product or pharmaceutical product packaging.

26. The apparatus of claim 22, wherein the scanning unit is operable to: direct coherent radiation sequentially onto each of plurality of regions of a surface of the article, and to collect a set comprising groups of data points from signals obtained when the coherent radiation scatters from the different regions of the article, wherein different ones of the groups of data points relate to scatter from the respective different regions of the article; and wherein the processing unit is operable to determine a signature of the article from the set of data points.

27. The apparatus of claim 22, further comprising a submission unit operable to send the biometric type signature for storage in a database.

28. The apparatus of claim 27, wherein the submission unit is operable to send the biometric type signature to be associated in the database with the identifier code for the article.

29. The apparatus of claim 22, wherein in a later verification, a result can be determined from one or both of the identifier code and the biometric type signature, in accordance with a desired result authentication certainty level.

30. The apparatus of claim 22, wherein the identifier code for the article is assigned to the article according to the unique identity or group identify of the article to enable identification of the article distinct from other similar articles.

31. Apparatus for validating the authenticity of an article, the apparatus comprising:
a reading unit operable to reading an assigned code from an article;
a processing unit operable to extract from the assigned code an identifier for the article and a biometric type signature for the article;
a comparison unit operable to use the identifier as a first authentication method to determine the authenticity of the article by comparing the extracted identifier to a record of one or more valid identifiers; and
a comparison unit operable to use the biometric type signature as a second authentication method to determine the authenticity of the article by comparing the extracted biometric type signature to a biometric type signature generated from analysis of intrinsic surface or internal structure of an area of the article from where the applied code is read.

32. The apparatus of claim 31, wherein the processing unit is operable to extract from the assigned code a biometric type signature for the article by decoding the biometric type signature from the assigned code or a part thereof.

33. The apparatus of claim 31, wherein the combined code is a barcode.

34. The apparatus of claim 31, wherein the article is a pharmaceutical product or pharmaceutical product packaging.

35. The apparatus of claim 31, further comprising a scanning unit operable to: directing coherent radiation sequentially onto each of plurality of regions of a surface of the article; and collect a set comprising groups of data points from signals obtained when the coherent radiation scatters from the different regions of the article, wherein different ones of the groups of data points relate to scatter from the respective different regions of the article; and a processing unit operable to determine a signature of the article from the set of data points.

36. The apparatus of claim 31, further comprising a comparison unit operable to use the biometric type signature as a third authentication method by comparing the biometric type signature generated from analysis of intrinsic surface or internal structure of an area of the article from where the applied code is read to a biometric type signature retrieved from a database.

37. The apparatus of claim 31, further comprising a transmission unit operable to transmit the biometric type signature to a remote comparison unit for use as a third authentication method by comparing the biometric type signature generated from analysis of intrinsic surface or internal structure of an area of the article from where the applied code is read to a biometric type signature retrieved from a database.

38. The apparatus of claim 36, wherein the biometric type signature retrieved from the database is retrieved by using the identifier code for the article as a search term.

39. The apparatus of claim 36, comprising selectively using the third authentication method for less than all articles validated by the apparatus, wherein articles are selected for use of the third authentication method in accordance with one or more of: a random selection, a maximum number of articles interval, a perceived damage to the applied code, and an encoding protocol or signature used to encode the biometric type signature in the applied code.

40. The apparatus of claim 31, wherein an authentication result can be determined from one or both of the first and second authentication methods, in accordance with a desired result authentication certainty level.

41. The apparatus of claim 40, wherein the desired result authentication certainty level is predetermined in accordance with one or more of an intended use of the article, the nature of the article, a service entitlement provided by the article, an access entitlement provided by the article, the value of the article or a rights level of an operator.

42. The apparatus of claim 40, wherein the desired result authentication certainty level is adjusted following receipt of an authenticity result from the first authentication method.

43. The apparatus of claim 31, wherein the identifier code for the article is assigned to the article according to the unique identity or group identify of the article to enable identification of the article distinct from other similar articles.

44. An article comprising an applied code thereon, which applied code includes an identifier code for the article and a biometric type signature for the article, the biometric type signature having been generated from analysis of intrinsic surface or internal structure of a part of an article to which the applied code is applied.

45. The article of claim 44, wherein the biometric type signature in the applied code is in encoded form.

46. The article of claim 44, wherein the combined code is a barcode.

47. The article of claim 44, wherein the article is a pharmaceutical product or pharmaceutical product packaging.

48. The article of claim 44, wherein the biometric type signature is generated by: directing coherent radiation sequentially onto each of plurality of regions of a surface of the article; collecting a set comprising groups of data points from signals obtained when the coherent radiation scatters from the different regions of the article, wherein different ones of the groups of data points relate to scatter from the respective different regions of the article; and determining a signature of the article from the set of data points.

49. The article of claim 44, wherein the identifier code for the article is assigned to the article according to the unique identity or group identify of the article to enable identification of the article distinct from other similar articles.
